(19) United States
(12) Patent Application Publication
(10) Pub. No.: US 2016/0174032 A1
(43) Pub. Date: Jun. 16, 2016

(54) Automated onsite information search and multimedia method and system

(71) Applicants: Alfred Xueliang Xin, Cincinnati, OH (US); Sherry Xiaoli Sun, Cincinnati, OH (US)

(72) Inventors: Alfred Xueliang Xin, Cincinnati, OH (US); Sherry Xiaoli Sun, Cincinnati, OH (US)

(21) Appl. No.: 14/665,791

(22) Filed: Mar. 23, 2015

Related U.S. Application Data
(63) Continuation of application No. 14/630,212, filed on Feb. 24, 2015.
Application No. 14/630,212 is a continuation of application No. 14/599,459, filed on Jan. 17, 2015.
Application No. 14/599,459 is a continuation of application No. 14/566,116, filed on Dec. 10, 2014.

(51) Int. Cl. H04W 4/02; H04L 29/08

(52) U.S. Cl. CPC H04W 4/021; H04L 67/20

(57) ABSTRACT

The invented method and system consists of a software application installed on a mobile device with internet connection and a geographical positioning device; a remote server and or an onsite wireless communication apparatus. The software application communicates and transfers data with the remote server or the onsite wireless communication apparatus. When user is in, at or close to a business, facility or an entity, or within a signal range of the onsite wireless communication apparatus, the software application automatically alerts the user. Displays, live updates information, plays live or recorded multimedia programs from the business, facility or entity. The remote server and the onsite wireless communication apparatus may communicate and transfer data to one another, or from a third party database or webserver and forward data to the software application. User may search specific information within or related to the business, facility or entity.

### BACKGROUND OF INVENTION

Mobile device users go to visit places such as a business, a facility or an entity with a range of functions and capacities may not be aware of all the information, services, or accurate places of products and live or recorded information or programs provided in, at or close to those places. Therefore there is a need to provide them with automated system, and users don't have to do anything to have it activated and the system will show them what are offered at those places on popup windows above locked or unlocked screen of a mobile device: the system would automatically alert them and automatically displays static or live information and or performs multimedia programs, including but not limited to live or pre-recorded audio, and or visual programs.

an onsite automated information search and multimedia method and system consists of a software application installed on a mobile device with internet connection and a geographical positioning device; a remote server and or an onsite wireless communication apparatus that is capable of hosting and or receiving and storing data and information; and capable of creating, publishing, processing and broadcasting any forms and means of data and information. Said software application communicates and transfers data with said remote server and or said onsite wireless communication apparatus. When a user is in, at or close to a business, facility or an entity, or within a signal range of said onsite wireless communication apparatus, said software application automatically alerts said user and displays information, plays live or recorded multimedia programs from said business, facility or entity. Said remote server and said onsite wireless communication apparatus may communicate and transfer data to one another. Said remote server and said onsite wireless communication apparatus may also communicate and transfer data from a third-party database or webserver and forward said data to said software application. Said user may search specific information within or related to said business, facility or entity.

### FIELD OF THE INVENTION

The current invention is related to automated onsite information and specific information search and onsite live or recorded performances of multimedia programs provided by onsite business, facility or entity.

### SUMMARY OF THE INVENTION

An automated information search and multimedia method and system consists of a software application installed on a mobile device with internet connection and a geographical positioning device; a remote server and or an onsite wireless communication apparatus. Said software application communicates and transfers data with said remote server and or said onsite wireless communication apparatus which is capable of hosting and or receiving and storing data and information; and capable of creating, publishing, processing and broadcasting any forms and means of data and information. When user is in, at or close to a business, facility or an entity, or within a signal range of the onsite wireless communication apparatus, said software application automatically alerts said user and displays information, plays live or recorded multimedia programs from said business, facility or entity. Said remote server and said onsite wireless communication apparatus may communicate and transfer data to one another. Said remote server and or onsite wireless communication apparatus may also communicate and transfer data from a third-party database or webserver and allow said data to communicate with said software application via said remote wireless connection. User may search specific information within or related to said business, facility or entity.

User may search specific information within or related to said business, facility; or listen to and or watch live or recorded programs provided by said business, facility or entity.

information and multimedia programs from a third-party business, a facility or entity may be displayed on window and or played during information, and or live or recorded multimedia programs are shown by said business, facility or entity.

Said onsite wireless communication apparatus is capable of processing, creating forms of information and programs via graphical user interface, and publishing and broadcasting said information and programs. Said onsite wireless communication apparatus may communicate to one another either via said remote server or radio signals from one another within a range. Said onsite wireless communication apparatus may configure a number of wireless signal extenders as to expand signal-covering areas.

Said onsite wireless communication apparatus configured with multimedia devices as a portable, standalone and plug-and-play communication equipment and a core part of the entire architecture shall provide benefits for users from all walks of life (businesses, entertainment facilities, schools, small village or towns and etc. in the world) with wireless broadcasting means in their localities without having to upload and create information and programs to the internet first or build up a broadcasting tower, buy and install and configure complicated sets of equipment, users and or audiences of live programs and information may get direct access to said live or recorded programs and static or live information onsite either having or not having internet connections and or cellphone signals with their mobile devices and said mobile devices extensions; and by configuring said onsite wireless communication apparatus with a set of wireless routers and or signal extenders, said users may be able to cover desired broadcasting range with a very little costs.

Not only said wireless communication apparatus benefits populations in developed communities, regions or countries, it shall greatly benefits undeveloped and geographically isolated places and would allow anyone like to have their own wireless communication system without having to build up a radio or TV station; Users of said equipment don't have to hire system administrators to configure and maintain a network configured with a number of hard and software systems, and there is no more need to make sure that all the hardware and software are compatible to one another; said equipment with assigned unique identification code allow them to connected to remote server and decide if they want to upload created information and or live or recorded programs with a few clicks from menu selections; and communication among said equipment and remote server enable information published and updated automatically with connections of geographical references without involving in IP address.

### BRIEF DESCRIPTION OF DRAWINGS

FIG. 1-A is flow chart that demonstrates logical flows of an automated onsite information search and multimedia method and system.

FIG. 2-A displays specific position of a product located on store shelf in an aisle within a supermarket.

FIG. 2-B shown a visual program play on introduction of an onsite restaurant.

FIG. 2-C is a screen of a cinema's information page with names of movies.

### PREFERRED EMBODIMENT

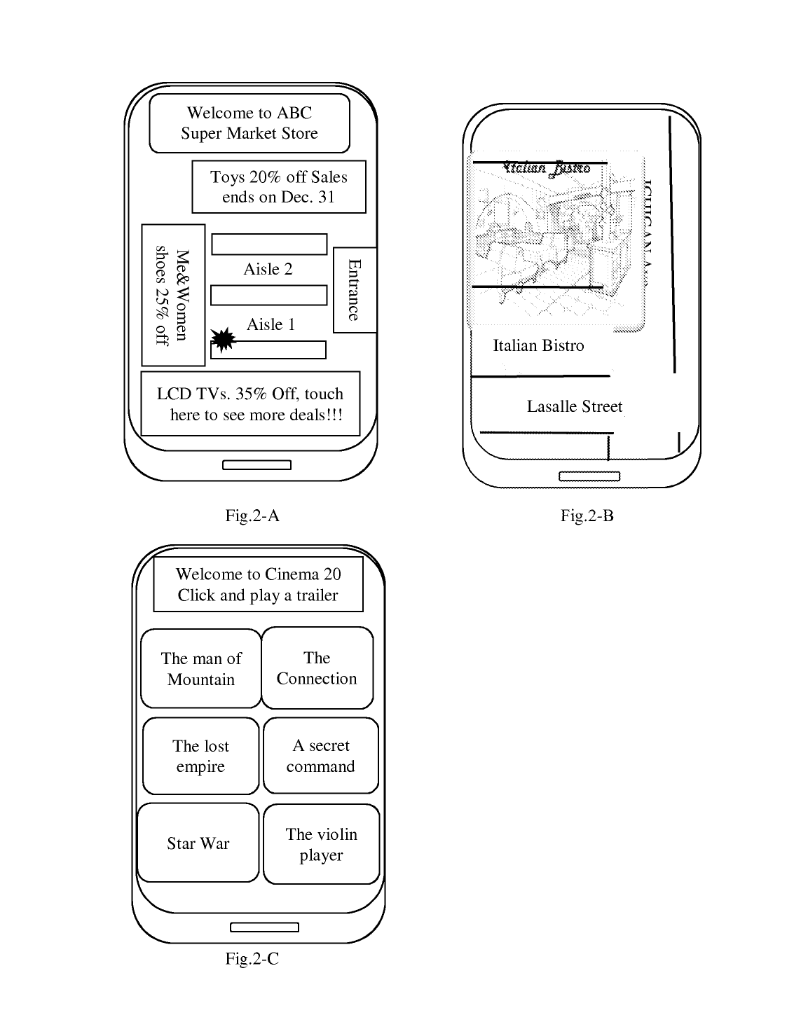

Referencing to drawings in Fig.-A and FIG. 2-A, a preferred embodiment of said automated onsite information search and multimedia system. A user with a cellphone installed with software application of said automated onsite information search and multimedia system is in a supermarket, and said user's location is pinpointed by digital map and information and media program created by said supermarket is activated and forwarded to said cellphone from a remote server.

Said remote server automatically checks its database on said location and its identity, and finds said location is one of said locations registered with a national chain that runs a database and webserver. It has been authorized on database of said remote server to allow direct connection between said database and webserver of said national chain and said software application installed on said cellphone via said remote server or via an onsite wireless communication apparatus. Starting from this point and via said remote server, said database and webserver of said national chain and said software installed on said cellphone directly communicate and transfer data, commands and requests. All information and programs received on said software application installed on said cellphone are directly sent out from said database and webserver of said national chain.

When said user enters said supermarket, said software application plays sound alert and gets attention of said user; a pre-recorded audio announces a welcome message and new products and good deals of said market for said day with location images; and also displays a text entering box allowing shoppers to search for specific product. Said user did not use text enter box, rather speaks to said microphone on said cellphone and looking for “ACB brand coffee”, said database and webserver of said national chain locates said product and sends back information and flashing with “Star” sign on a place on a shelf in aisle 1. Said user directly goes to said place and picks up said product without wasting anytime.

As soon as said user leaves said location of said supermarket, said remote server cut off said connection between said database and webserver of said national chain and said software application installed on said cellphone, said software application automatically is closed on screen of said cellphone.

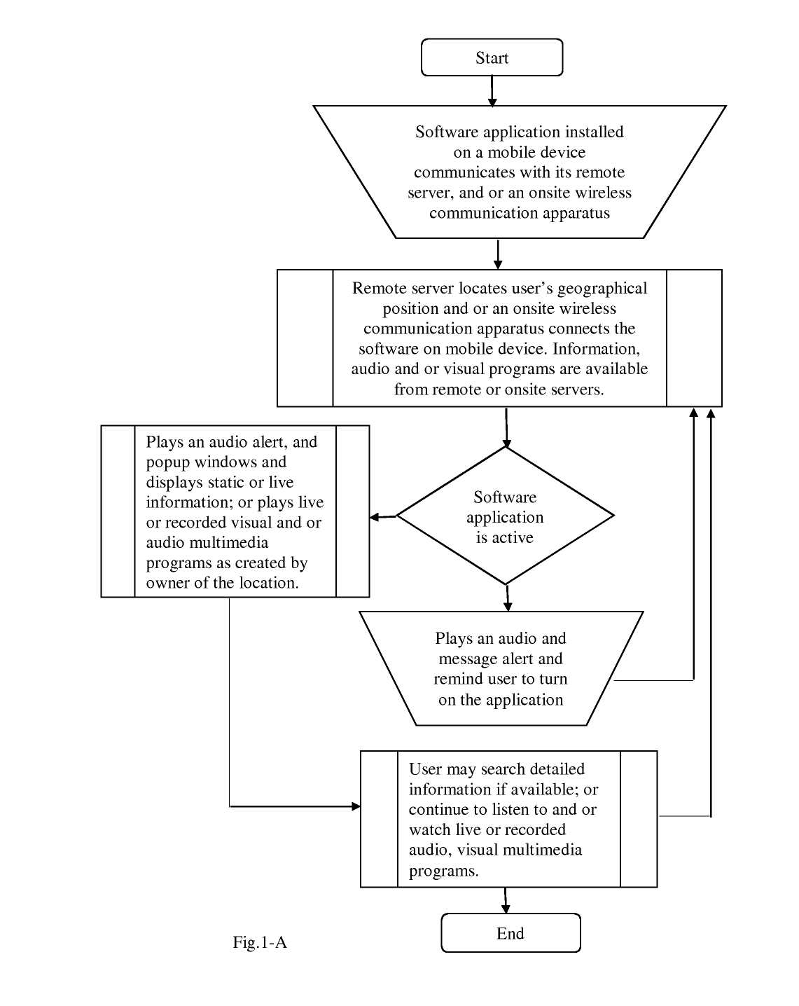

Referencing to drawings in FIG. 1-A and FIG. 2-B of another preferred embodiment of said automated onsite information search and multimedia system. A user with a cellphone installed with software application of an automated onsite information search and multimedia system is outside of restaurant and read a menu board near its entrance. Said user's location is pinpointed by digital map and said software calculates that a timespan of the said user staying within a close range of said location is longer than 20 seconds and likely said user is interested in staying at said location and not a passerby, said software send its unique ID and location information to said remote server. Said remote server receives said information and, and then activates information and media program created by said restaurant forwards to said cellphone from a remote server.

Said software application plays sound alert and gets attention of said user; a recorded video clip, which was recorded by said restaurant owner with his cellphone and uploaded to said remote server, pops up on said cellphone screen and welcome said user and shows a brief introduction of said restaurant and also best sales dishes and best deals of said day; after said video play a menu displays on screen of said user's cellphone.

Online visitors get on website run by said remote server and locate said restaurant on a map by searching name of said business or related information, or directly find it on said map. When said online visitors click on location of said restaurant on said map, the same video greeting and the same information available for onsite visitors are also shown on said website.

Referencing to drawings in FIG. 1-A and FIG. 2-C of another preferred embodiment of said automated onsite information search and multimedia system. A user with a cellphone installed with software application of an automated onsite information search and multimedia system is inside of cinema and said user's location is pinpointed by digital map. Said remote server sends information and media programs created by said cinema to said cellphone.

Said software application plays a sound alert and gets attention of said user; a window page pops up with name of the movies shown on that day; an audio recording welcome said user and introduces said cinema briefly and asks said user to click on movie name and plays trailers of those movies.

Said administrators of remote server of said automated onsite information search and multimedia system created and inserts commercials and or information from third-party businesses and said commercials and information are displayed and or played during regular information and or programs to generate extra revenues for said cinema chains.

Referencing to drawings in FIG. 1-A of another preferred embodiment of said automated onsite information search and multimedia system. A user with a cellphone installed with software application of an automated onsite information search and multimedia system is at a concert hall and sitting in a back row.

An onsite wireless communication apparatus is installed in said concert hall and wired with a sets of video cameras sends live video broadcasting of performances from stage to said cellphone, and it also temporarily has audio and phone reception functions of said cellphone disabled in order to make sure that no noises disrupt said performance. Even though said user sits far back in said concert hall, he can clearly watch said performances on said stage.

Referencing to drawings in FIG. 1-A of another preferred embodiment of said automated onsite information search and multimedia system. A user with a cellphone installed with software application of an automated onsite information search and multimedia system is in football stadium sitting in a back row, and said user paid a fraction of price and bought a permit to watch onsite live video broadcasting.

An onsite wireless communication apparatus is wired with a sets of video cameras sends live visual broadcasting of the game. Said software application installed on said cellphone receives signals of a unique identification code of said onsite wireless communication apparatus and forwards said signals to a remote server for verification and make sure if said onsite wireless communication apparatus is licensed and authorized for live video broadcasting by said remote server.

After said remote server sends an approval signal to said software application installed on said cellphone, said software application opens a login window and asking said user to enter his permit number printed on his ticket. After said user enters its permit number, said software starts to receive and show live video broadcasting from said onsite wireless communication apparatus. Even though said user sits a back row of said stadium, he can clearly watch said match in the field. During breaks of said match, commercials and or information of any third-party are shown on said software application.

Said onsite wireless communication apparatus is connected to said remote server and transferring onsite information and live visual program to said remote server. Said remote sever transfers said onsite information and live visual program to its website, and also to said software application installed on said mobile device. Users of said software application from different places may select said information and live program from said remote information and program menu option, pay a fee and read said information and watch said live game; other audiences may also pay a fee and read and watch said same on other mobile devices, computers and TVs with internet connections.

Referencing to drawings in FIG. 1-A of another preferred embodiment of said automated onsite information search and multimedia system. A user with a cellphone installed with software application of an automated onsite information search and multimedia system gets in a resort town with no knowledge where to go.

An onsite wireless communication apparatus is located in said town center sends welcome video to said cellphone, briefly introduces said town and then display a map of said town on a window. Said user clicks on interesting places shown on said map and get detailed information about those places with static information and or recorded video clips.

Referencing to drawings in FIG. 1-A of another preferred embodiment of said automated onsite information search and multimedia system. A user with a cellphone installed with software application of an automated onsite information search and multimedia system is at an airport and trying to find information and routing to get to his flight.

An onsite wireless communication apparatus located at said airport sends welcome video to said cellphone, briefly introduces said airport structures and then asks said user to enter his flight information by rather typing into a text box on said welcome window, or give an oral command; said user speaks his flight number, said onsite wireless communication apparatus retrieves and displays flight information and boarding location from a database and drawing a map routing map for said user based on his location and leading his way to said boarding terminal, and also constantly updating flight information with streaming data shown on window.

Referencing to drawings in FIG. 1-A of another preferred embodiment of said automated onsite information search and multimedia system. A user with a cellphone installed with software application of an automated onsite information search and multimedia system is in a mountain with a group of campers and without cellphone signal, and said user gets lost in said wood.

Fortunately said organizer of said travel group brings an onsite wireless communication apparatus and published camp location on a map and all important information on said application window, and also live video onsite of said camp is broadcasted. Said user looks at said software application on said cellphone, it shows where said camp center is and routes to get back to said camp center and also hears that said other member of said group talking to him over said speaker and encourage him to come back soon before it gets dark.

Referencing to drawings in FIG. 1-A of another preferred embodiment of said automated onsite information search and multimedia system. A small village or small town installed a unit of wireless communication apparatus. Instead of building up a radio station and or a TV station, said small village or small town publishes information about said places and update news and also provide people in said places with live audio and radio broadcasting when needed.

When any information and or programs are available or updated, people in said places with their cellphones installed with software application of an automated onsite information search and multimedia system will be alerted with a special ringtone and updated information and or programs are automatically shown above either locked or unlocked screens of said cellphones.

Said administrators of said wireless communication inserts commercials and or information from local businesses and said commercials and information are displayed and or played during regular information and or programs to generate revenues for said village and town.

Referencing to drawings in FIG. 1-A of another preferred embodiment of said automated onsite information search and multimedia system. A user with a mobile device installed with said software application visits an ancient town site in Greece. The administrators of said ancient town created information based different areas of said town.

At the entrance of said town a map with different areas marked with functions, such as town center, market place, residential and family life areas and town defense architectures, is shown on said software application, a recorded audio speech greets visitors, and gives general introduction of the history of said town. When said user walks through different functional areas, a recorded video to demonstrate live scenes and daily life of said town people is shown on said software application accompanied with narrations.

Since narrated live scenes come along with said user during entire trip, said user leaves said ancient Greek town with a lot of vivid images and impressions in his memory.

Online visitors get on website run by said remote server and locate said ancient town on a map by searching name of said town or related travel information, or directly find it said a map. Said visitors click on the location of said town on said map, and details of said town shown up on said map. Said visitors click on sub locations marked with different functions on said map, the same prerecorded videos played for onsite visitors are played.

The embodiments are mainly illustrations of the invention, advantages of the invention may be learned by practice, realized and attained by means of the elements and combinations particularly pointed out in said claims. Further it is to be understood that both the foregoing general descriptions and detailed descriptions are exemplary and explanatory only and are not limited to the invention as claimed.

It claims:

1. An automated onsite information search and multimedia method and system comprising:
a. software application installed on a mobile device coupled to internet connection and a geographical positioning device;
b. a remote server is capable of communicating with said software application and automatically updating location of said software application,
c. an onsite wireless communication apparatus is capable of hosting and or receiving and storing data and information from wired or wireless connections; and capable of creating, publishing, processing any forms of information and programs via a GUI (Graphical User Interface), and capable of transferring data from and to other multimedia devices and broadcasting said forms of information and programs;
d. said software application is capable of communicating and transferring data and signals to and from said remote server and or said on-site wireless communication apparatus;
e. said remote server and said onsite wireless communication apparatus are capable of communicating and transferring data to one another.

2. An automated onsite information search and multimedia method and system comprising:
a. software application installed on a mobile device such as a cellphone;
b. an onsite wireless communication apparatus is capable of hosting and or receiving and storing data and information from wired or wireless connections, and capable of creating, publishing, processing any forms of information and programs via a GUI (Graphical User Interface), and capable of transferring data from and to other multimedia devices and broadcasting said forms of information and programs;
c. said software application is capable of communicating and transferring data and signals from and to said on-site wireless communication apparatus;
d. said onsite wireless communication apparatus is capable of communicating and transferring data to and from an remote server;
e. said onsite wireless communication apparatus is capable of sharing data with one another.

3. The automated onsite information search and multimedia method and system of claim 1 wherein said software application installed on said mobile device coupled with said a geographical positioning device is capable of updating and sending accurate physical location of said mobile device to said remote server.

4. The automated onsite information search and multimedia method and system of claims 1 and 2 wherein said software application on said mobile device coupled to graphic user interface is capable of submitting a request by user for specific information search within a range, postal address and or at location of said mobile device; and displays requested information sent back by said remote server and or said onsite wireless communication apparatus according to their physical locations and or actual floor layouts within a range of said mobile device.

5. The automated onsite information search and multimedia method and system of claims 1 and 2 wherein said software application on said mobile device is capable of being deployed on a web browser installed to said mobile device.

6. The automated onsite information search and multimedia method and system of claims 1 and 2 wherein said software application on said mobile device is capable of displaying floor layouts within structures of a building, or layout of structures and or functional areas of a facility or an entity.

7. The automated onsite information search and multimedia method and system of claim 1 wherein said remote server is capable of submitting requests to multiple internet websites and or database, and optimizing searching results for further process.

8. The automated onsite information search and multimedia method and system of claims 1 and 2 wherein said software application is capable of accepting oral commands from said user via a microphone installed on said mobile device.

9. The automated onsite information search and multimedia method and system of claims 1 and 2 wherein said software application is capable of automatically displaying information and or multimedia programs on popup windows above locked or unlocked screen of said mobile device when said user in, at or close to said business, facility or entity.

10. The automated onsite information search and multimedia method and system of claims 1 and 2 wherein said software application is capable of receiving an uniquely assigned digital code sent out by a signal emitter located within premises of said business, facility or entity; said software application installed on said mobile device sends said uniquely assigned digital code to its host server, said remote server is capable of verifying said digital coded for further process.

11. The automated onsite information search and multimedia method and system of claim 9 wherein said software application is capable of playing a special sound, ringtone or announcement to alert said user simultaneously with said popup windows.

12. The automated onsite information search and multimedia method and system of claim 9 wherein said software application is capable of making said popup window disappeared from screen of said mobile device when said user walks away and or leaves said business, facility or entity from a close range, and or said assigned digital code signal weakened and replaced by another stronger digital code signal assigned to another business.

13. The automated onsite information search and multimedia method and system of claim 9 wherein said system is capable of automatically announcing said information via a speaker installed on said mobile device.

14. The automated onsite information search and multimedia method and system of claims 1, 2 and 9 wherein said software application is capable of searching and selecting and displaying information from any third-party related to selected business, facility or entity posted on websites on screen of said mobile device.

15. The automated onsite information search and multimedia method and system of claims 1, 2 and 9 wherein said software application is capable of playing live or recorded audio, and or visual onsite performances, games or any forms of activities, and any form of multimedia programs broadcasted by said business, facility or entity.

16. The automated onsite information search and multimedia method and system of claim 9 wherein said software application is capable of allowing user to make a phone call to said business, facility or entity via a touch button displayed on its screen on said mobile device, or via oral command.

17. The automated onsite information search and multimedia method and system of claims 1 and 2 wherein said software application installed on said mobile device and or remote server or onsite are capable of calculating timespan of said user staying within a close range of location of said business, facility or entity as to determine that said user intends to stay at or visit said location, and is not a passerby.

18. The automated onsite information search and multimedia method and system of claims 1 and 2 Wherein said remote server and or said onsite wireless communication apparatus are capable of allowing said business, facility or entity to setup a defined physical range for their location via web interface or GUI, and allowing its information and or multimedia programs to be activated and give an alert to a user with said mobile device installed with said software application, further activate popup windows and display said information and or multimedia programs.

19. The automated onsite information search and multimedia method and system of claims 1, 2 and 9 wherein said software system is capable of playing live or recorded visual and audio programs simultaneously.

20. The automated onsite information search and multimedia method and system of claims 1, 2 and 9 wherein said software application is capable of replacing and or switching between web pages, windows and multimedia programs.

21. The automated onsite information search and multimedia method and system of claim 1 wherein said remote server, and or software application installed on said mobile device are capable of calculating effective physical parameter for a location or premises to activate related information and or multimedia programs by comparing and measuring said location to physical distances of other locations.

22. The on-site commercial and information media method and system of claims 1 and 9 wherein said software application installed on said mobile device is capable of detecting, and further automatically connecting to and communicating with a remote server setup for a region and or a country, and further receiving and updating information and data from said region and or said country.

23. The automated onsite information search and multimedia method and system of claims 1 and 9 wherein said software application installed on said mobile device is capable of identifying a region and or a country and automatically adopting a digital map of said region and or country.

24. The automated onsite information search and multimedia method and system of claims 1, 2 and 9 wherein said software application installed on said mobile device is capable of identifying a region and or a country and further displaying and using language of said region and or said country, and or along with first language as said user selected at installation of said application software.

25. The automated onsite information search and multimedia method and system of claims 1, 2 and 9 wherein said software application is capable of configuring, and or being added to, and or embedded with an software application applied to a mobile device.

26. The automated onsite information search and multimedia method and system of claims 1, 2, 8 and 9 wherein said software application coupled with said remote server and or said onsite wireless communication apparatus is capable of searching specific location of an object, a merchandise, service and or functional area based on an area, categorized merchandise and or floor-layout map.

27. The automated onsite information search and multimedia method and system of claims 1, 2 and 9 wherein said software application is capable of temporarily disabling sound, incoming phone reception and or audio function of said mobile device.

28. The automated onsite information search and multimedia method and system of claims 1, 2 and 9 wherein information, data and or multimedia programs of a third-party may be inserted, displayed, and or played with information, data and live or recorded multimedia programs of said business, facility or entity.

29. The automated onsite information search and multimedia method and system of claims 1 and 2 wherein said on-site onsite wireless communication apparatus is capable of creating and automatically updating information, and broadcasting live or recorded multimedia programs.

30. The automated onsite information search and multimedia method and system of claims 1 and 2 wherein said remote server is capable of issuing and sending authorizations for permits and allowed functions to said onsite wireless communication apparatus; and is capable of receiving signals sent from said onsite wireless communication apparatus via internet or forwarded via said software application installed on said mobile device, and further verifying said signals for authorization status for permits and or allowed functions, and still further allowing or rejecting information and or multimedia programs displayed and or played on said software application installed on said mobile device.

31. The automated onsite information search and multimedia method and system of claims 1 and 2 wherein said onsite wireless communication apparatus is capable of communicating with said software application installed on said mobile device, and further verifying for authorization status, permit and or allowed functions, and still further allowing or not allowing information and or multimedia programs displayed and or played on said software application installed on said mobile device.

32. The automated onsite information search and multimedia method and system of claims 1 and 2 wherein said onsite wireless communication apparatus is capable of transferring data to one another either by communicating directly within adjacent locations or via internet connection with said remote server, and further displaying said data on said software application, and still further said remote server is capable of utilizing said data for offsite and or online data processing.

33. The automated onsite information search and multimedia method and system of claims 1 and 2 wherein said onsite wireless communication apparatus is capable of adjusting signals broadcasting range and parameters by scaling up or down strength of said signals.

34. The automated onsite information search and multimedia method and system of claims 1 and 2 wherein said remote server is capable of connecting to and transferring data from a database and or an internet of a third-party and allowing said data to communicate with said software application installed on said mobile device via a connection of said remote server.

35. The automated onsite information search and multimedia method and system of claims 1 and 2 wherein said onsite wireless communication apparatus is capable of configuring local servers, wireless routers and or wireless signal extenders to extend signal-covering range.

36. An automated onsite information search and multimedia method and system comprising steps and functions of: a software application installed on a mobile device coupled with a geographical positioning device and internet connection is capable of communicating and transferring data from and to a remote server and or an onsite wireless communication apparatus; said onsite wireless communication apparatus is capable of hosting and or receiving and storing data and information from wired or wireless connections, and capable of creating, publishing, processing any forms of information and programs via a GUI (Graphical User Interface), and capable of transferring data from and to other multimedia devices and broadcasting said forms of information and programs;
said software application is capable of communicating and transferring data and signals from and to said on-site wireless communication apparatus;
said remote server and said onsite wireless communication apparatus are capable of communicating and transferring data to one another;
said onsite wireless communication apparatus is capable of sharing data with one another;
said software application installed on said mobile device coupled with said a geographical positioning device is capable of updating and sending accurate physical location of said mobile device to said remote server;
said software application on said mobile device coupled to graphic user interface is capable of submitting a request by user for specific information search within a range, postal address and or at location of said mobile device; and displays requested information sent back by said remote server and or said onsite wireless communication apparatus according to their physical locations and or actual floor layouts within a range of said mobile device;
said software application on said mobile device is capable of being deployed on a web browser installed to said mobile device;
said software application on said mobile device is capable of displaying floor layouts within structures of a building, or layout of structures and or functional areas of a facility or an entity;
said remote server is capable of submitting requests to multiple internet websites and or database, and optimizing searching results for further process;
said software application is capable of accepting oral commands from said user via a microphone installed on said mobile device;
said software application is capable of automatically displaying information and or multimedia programs on popup windows above locked or unlocked screen of said mobile device when said user in, at or close to said business, facility or entity;
said software application is capable of receiving an uniquely assigned digital code sent out by a signal emitter located within premises of said business, facility or entity; said software application installed on said mobile device sends said uniquely assigned digital code to its remote server, said remote server is capable of verifying said digital coded for further process;
said software application is capable of playing a special sound, ringtone or announcement to alert said user simultaneously with said popup windows;
said software application is capable of making said popup window disappeared from screen of said mobile device when said user walks away and or leaves said business, facility or entity from a close range, and or said assigned digital code signal weakened and replaced by another stronger digital code signal assigned to another business;
said system is capable of automatically announcing said information via a speaker installed on said mobile device;
said software application is capable of searching and selecting and displaying information from any third-party related to selected business, facility or entity posted on websites on screen of said mobile device;
said software application is capable of playing live or recorded audio, and or visual onsite performances, games or any forms of activities, and any form of multimedia programs broadcasted by said business, facility or entity;
said software application is capable of allowing user to make a phone call to said business, facility or entity via a touch button displayed on its screen on said mobile device, or via oral command;
said software application installed on said mobile device and or remote server or onsite wireless communication apparatus are capable of calculating timespan of said user staying within a close range of location of said business, facility or entity as to determine that said user intends to stay at or visit said location, and is not a passerby;
said remote server and or said onsite wireless communication apparatus are capable of allowing said business, facility or entity to setup a defined physical range from their location to allow its information and or multimedia programs to be activated and give an alert to a user with said mobile device installed with said software application, further activate popup windows and display said information and or multimedia programs;
said software system is capable of playing live or recorded visual and audio programs simultaneously;
said software application is capable of replacing and or switching between web pages, windows and multimedia programs;
said remote server, and or software application installed on said mobile device are capable of calculating effective physical parameter for a location or premises to activate related information and or multimedia programs by comparing and measuring said location to physical distances of other locations;
said software application installed on said mobile device is capable of detecting, and further automatically connecting to and communicating with a remote server setup for a region and or a country, and further receiving and updating information and data from said region and or said country;
said software application installed on said mobile device is capable of identifying a region and or a country and automatically adopting a digital map of said region and or country;
said software application installed on said mobile device is capable of identifying a region and or a country and further displaying and using language of said region and or said country, and or along with first language as said user selected at installation of said application software;
said software application is capable of configuring, and or being added to, and or embedded with an software application applied to a mobile device;
said software application coupled with said remote server and or said onsite wireless communication apparatus is capable of searching specific location of an object, a merchandise, service and or functional area based on an area, categorized merchandise and or floor-layout map;
said software application is capable of temporarily disabling sound, incoming phone reception and or audio function of said mobile device;
information, data and or multimedia programs of a third-party may be inserted, displayed, and or played with information, data and live or recorded multimedia programs of said business, facility or entity;
said on-site onsite wireless communication apparatus is capable of creating and automatically updating information, and broadcasting live or recorded multimedia programs;
said remote server is capable of issuing and sending authorizations for permits and allowed functions to said onsite wireless communication apparatus; and is capable of receiving signals sent from said onsite wireless communication apparatus via internet or forwarded via said software application installed on said mobile device, and further verifying said signals for authorization status, permit and or allowed functions, and still further allowing or rejecting information and or multimedia programs displayed and or played on said software application installed on said mobile device;
said onsite wireless communication apparatus is capable of communicating with said software application installed on said mobile device, and further verifying for authorization status, permit and or allowed functions, and still further allowing or not allowing information and or multimedia programs displayed and or played on said software application installed on said mobile device;
said onsite wireless communication apparatus is capable of transferring data to one another either by communicating directly within adjacent locations or via internet connection with said remote server, and further displaying said data on said software application, and still further said remote server is capable of utilizing said data for offsite and or online data processing;
said onsite wireless communication apparatus is capable of adjusting signals broadcasting range and parameters by scaling up or down strength of said signals;
said remote server is capable of connecting to and transferring data from a database and or an internet of a third-party and allowing said data to communicate with said software application installed on said mobile device via a connection of said remote server;
said onsite wireless communication apparatus is capable of configuring local servers, wireless routers and or wireless signal extenders to extend signal-covering range.
